(19) United States
(12) Patent Application Publication
(10) Pub. No.: US 2014/0059012 A1
(43) Pub. Date: Feb. 27, 2014

(54) Management of Database Deployment

(71) Applicants: Sameer MALHOTRA, Short Hills, NJ (US); Nazario PARSACALA, Piscataway, NJ (US); Jooi-Teong CHUAH, East Brunswick, NJ (US)

(72) Inventors: Sameer MALHOTRA, Short Hills, NJ (US); Nazario PARSACALA, Piscataway, NJ (US); Jooi-Teong CHUAH, East Brunswick, NJ (US)

(73) Assignee: BANK OF AMERICA, Charlotte, NC (US)

(21) Appl. No.: 13/591,033

(22) Filed: Aug. 21, 2012

(51) Int. Cl. G06F 17/00

(52) U.S. Cl. 707/689; 707/E17.005

(57) ABSTRACT

Apparatuses, computer readable media, methods, and systems are described for provisioning of databases, which may include processing a request to generate a database, wherein the request comprises a database parameter; determining a lease term for the database; generating the database based on the database parameter; and communicating a notification containing information regarding the database and the lease term.

### BACKGROUND

Databases have long been used as tools for organizing collections of data. Databases may be organized so that the data can be accessed, managed, and updated. Computer databases, for instance, may contain aggregations of data records or files. Database management, however, can be intensive of time and resources of information technology staff. In view of such issues, improvements in database management are needed.

### BRIEF SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

According to aspects of example embodiments, apparatuses, computer readable media, methods, and systems are described for provisioning of databases.

In some aspects, apparatuses, computer readable media, methods, and systems are described for provisioning of databases, which may include processing a request to generate a database, wherein the request comprises a database parameter; determining a lease term for the database; generating the database based on the database parameter; and communicating a notification containing information regarding the database and the lease term.

Aspects of the embodiments may be provided in at least one non-transitory computer-readable medium and/or memory storing computer-executable instructions that, when executed by at least one processor, cause a computer or other apparatus to perform one or more of the process steps described herein.

These and other aspects of the embodiments are discussed in greater detail throughout this disclosure, including the accompanying drawings.

### BRIEF DESCRIPTION OF THE DRAWINGS

The present disclosure is illustrated by way of example and not limited in the accompanying figures in which like reference numerals indicate similar elements and in which:

FIG. 1 depicts an illustrative operating environment in which various aspects of the present disclosure may be implemented in accordance with example embodiments.

FIG. 2 depicts an illustrative block diagram of workstations and servers that may be used to implement the processes and functions of certain aspects of the present disclosure in accordance with example embodiments.

FIG. 3 illustrates an example system providing centralized database management for provisioning of databases in accordance with example embodiments of the disclosure.

FIG. 4 illustrates a system including multiple database servers in accordance with example embodiments of the disclosure.

FIG. 5 depicts an example flow diagram of a method, in accordance with example embodiments.

### DETAILED DESCRIPTION

In the following description of the various embodiments, reference is made to the accompanying drawings, which form a part hereof, and in which is shown by way of illustration various embodiments in which the disclosure may be practiced. It is to be understood that other embodiments may be utilized and structural and functional modifications may be made without departing from the scope and spirit of the present disclosure.

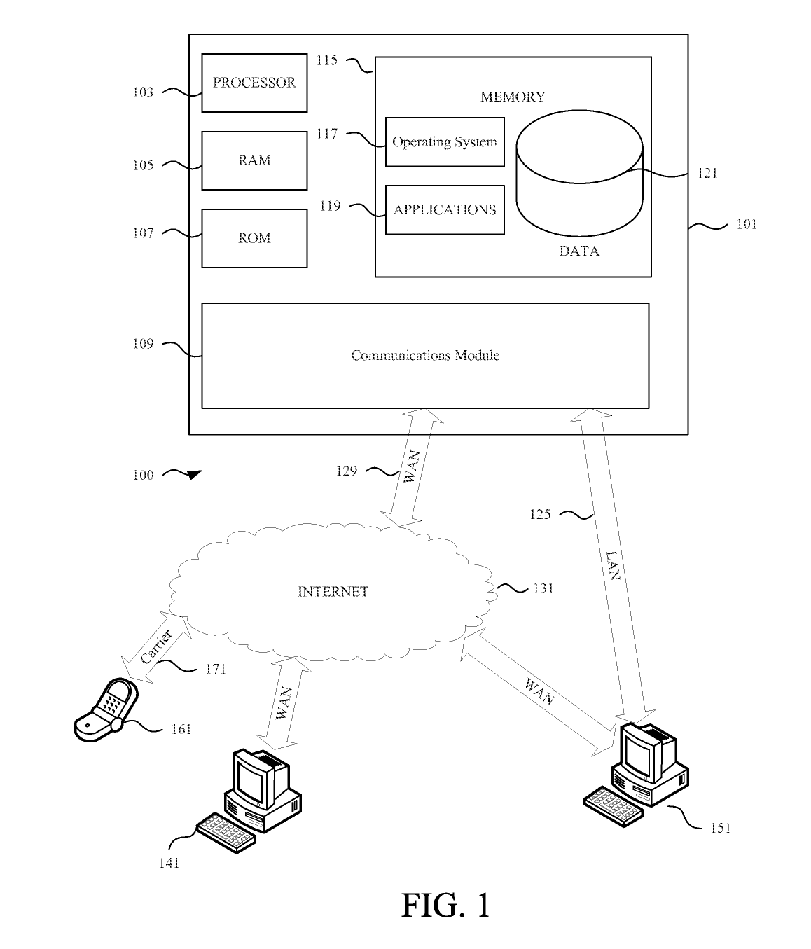

FIG. 1 illustrates an example of a suitable computing system environment 100 that may be used according to one or more illustrative embodiments. The computing system environment 100 is only one example of a suitable computing environment and is not intended to suggest any limitation as to the scope of use or functionality contained in the disclosure. The computing system environment 100 should not be interpreted as having any dependency or requirement relating to any one or combination of components shown in the illustrative computing system environment 100.

With reference to FIG. 1, the computing system environment 100 may include a computing device 101 having a processor 103 for controlling overall operation of the computing device 101 and its associated components, including random-access memory (RAM) 105, read-only memory (ROM) 107, communications module 109, and memory 115. Computing device 101 may include a variety of computer readable media. Computer readable media may be any available media that may be accessed by computing device 101, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computing device 101.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on computing device 101. Such a processor may execute computer-executable instructions stored on a computer-readable medium.

Software may be stored within memory 115 and/or storage to provide instructions to processor 103 for enabling computing device 101 to perform various functions. For example, memory 115 may store software used by the computing device 101, such as an operating system 117, application programs 119, and an associated database 121. Also, some or all of the computer executable instructions for computing device 101 may be embodied in hardware or firmware. Although not shown, RAM 105 may include one or more are applications representing the application data stored in RAM 105 while the computing device is on and corresponding software applications (e.g., software tasks), are running on the computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output. Computing system environment 100 may also include optical scanners (not shown). Exemplary usages include scanning and converting paper documents, e.g., correspondence, receipts, and the like, to digital files.

Computing device 101 may operate in a networked environment supporting connections to one or more remote computing devices, such as computing devices 141, 151, and 161. The computing devices 141, 151, and 161 may be personal computing devices or servers that include many or all of the elements described above relative to the computing device 101. Computing device 161 may be a mobile device (e.g., smart phone) communicating over wireless carrier channel 171.

The network connections depicted in FIG. 1 may include a local area network (LAN) 125 and a wide area network (WAN) 129, as well as other networks. When used in a LAN networking environment, computing device 101 may be connected to the LAN 125 through a network interface or adapter in the communications module 109. When used in a WAN networking environment, computing device 101 may include a modem in the communications module 109 or other means for establishing communications over the WAN 129, such as the Internet 131 or other type of computer network. It will be appreciated that the network connections shown are illustrative and other means of establishing a communications link between the computing devices may be used. Various well-known protocols such as TCP/IP, Ethernet, FTP, HTTP and the like may be used, and the system can be operated in a client-server configuration to permit a user to retrieve web pages from a web-based server. Any of various conventional web browsers can be used to display and manipulate data on web pages.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like.

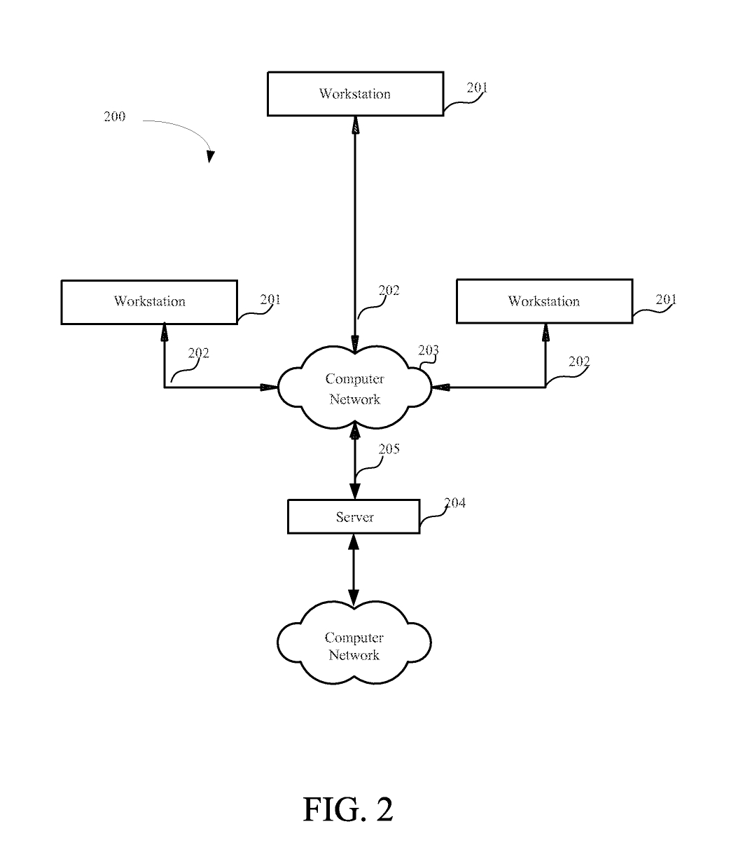

Referring to FIG. 2, an illustrative system 200 for implementing example embodiments according to the present disclosure is shown. As illustrated, system 200 may include one or more workstation computers 201. A workstation 201 may be, for example, a desktop computer, a smartphone, a wireless device, a tablet computer, a laptop computer, and the like. Workstations 201 may be local or remote, and may be connected by one of communications links 202 to computer network 203 that is linked via communications link 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, as well as network types developed in the future, and the like.

Managing of databases across an organization can be cumbersome task. Conventionally, databases are deployed in a haphazard fashion and lack centralized management. In some instances, distributed information technology departments may independently set up their databases, and the organization may unnecessarily service databases containing data that is rarely used. Maintaining infrequently used databases is an unneeded cost to the organization. Further, distributed database management makes it difficult for information technology professionals to determine who has provisioned which databases as well as how many databases have been provisioned.

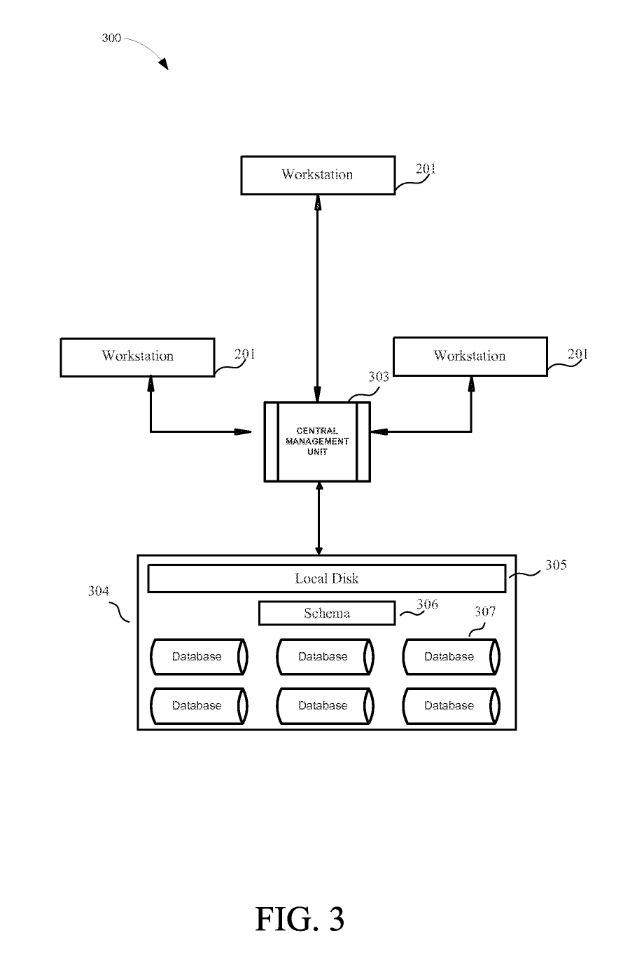

FIG. 3 illustrates an example system providing centralized database management for provisioning of databases in accordance with example embodiments of the disclosure. Provisioning may, for example, involve any of creation, modification, and deactivation of a database. In an example, system 300 may include one or more workstations 201, a central management unit (CMU) 303, and a database server 304. Each of CMU 303, workstations 201, and database server 304 may comprise one or more components, including, but not limited to, computer hardware (e.g., one or more computing devices 101), software, and memory. CMU 303, workstations 201, and database server 304 may communicate with one another via, for example, at least one of a wired network and a wireless network. Although FIG. 3 depicts only three workstations 201, a single CMU 303, and a single database server 304, system 300 may be implemented to include any number of these components, as well as other components that are not shown.

In an example, workstations 201 may implement a provisioning tool to instruct CMU 303 to provision one or more databases. The provisioning tool may be, for example, a software program that provides a graphical user interface through which a requesting entity may instruct CMU 303 to provision one or more databases. The requesting entity may be a user of workstation 201, a group of users (e.g., design team, members of a department or other group, and the like) using one or more workstations, a software program that automatically provisions databases, and the like.

In response to instructions received via the provisioning tool, CMU 303 may instruct the database server 304 to provision one or more databases. In an example, database server 304 may include one or more local disks 305 that physically store data on one or more schema 306 and data for one or more databases 307. A schema 306 may be a description of a logical organization of a particular database 307. Database server 304 may permit each database 307 to have its own unique schema, or may limit a total number of unique schemas that may be created.

When initially provisioning a database, workstation 201 may present a graphical user interface using the provisioning tool and prompt a requesting entity to specify parameters for the database. Example parameters may include storage capacity of the database (e.g., 35 gigabytes), memory capacity, processing capacity, lease term (e.g., requested lifetime of the database), authorized user(s) or organization(s) of the database, and the like. The lease term may, for example, indicate a lifetime of a database requested by a requesting entity or other requesting entity. For example, if a lease term is two months and a database is created on Apr. 1, 2012, the lease term of the database may expire on Jun. 1, 2012. The lifetime may be of finite duration, and CMU 303 may specify a maximum lifetime limit. Additional information the requesting entity may provide may include a name for at least one of the schema and the database, and permissions granted to schema users. Example permissions include who has the ability to create and alter a table within a database, available database views, packages/procedures/functions, sequences, synonyms, and who has the ability to create and alter a session. By way of example, a requesting entity may input, using a workstation 201, a request to provision a 20 GB database, for a period of three months, with Andy, Barbara, Curtis, Donna, and Elisa as authorized users. Alternatively or additionally, workstation 201 may store a list of database parameters and automatically cause CMU 303 to provision a database.

After the requesting entity has input desired database parameters, workstation 201 may communicate a provisioning request to CMU 303. The provisioning request may specify the requested database parameters as well as information about the requesting entity (e.g., identifier of requesting entity). Upon receipt of the provisioning request, CMU 303 may process the request and perform one or more of: (1) verifying that the requesting entity (e.g., user, workstation, and the like) is authorized to provision a database, and (2) confirm that the database server 304 has sufficient capacity to provision the requested database, as described in further detail below.

To verify that the requesting entity (e.g., user, workstation, and the like) is authorized to provision a database, CMU 303 may compare a requesting entity identifier included in the provisioning request with a listing of authorized requesting entity identifiers to determine whether the requesting entity has authority to provision the requested database(s). In the event the requesting entity is not on the list of authorized user identifiers, CMU 303 may deny the provisioning request. The listing of authorized requesting entity identifiers may also identify the rights of the requesting entity. Example rights may include a total size limit of databases that the requesting entity may provision, a total number of databases the requesting entity may provision, a maximum length of time of a lease term the requesting entity may provision, and types of databases the requesting entity is authorized to provision.

When processing the provisioning request, CMU 303 may determine what types of databases the requesting entity is authorized to provision. In some examples, CMU 303 may determine if there are any limits on the types of databases the requesting entity is authorized to provision. For example, if User A requests provisioning of a 10 GB database, but only has rights to create databases up to 5 GB, CMU 303 may deny the provisioning request. In an example, if the provisioning request is denied, CMU 303 may communicate a message to workstation 201 to inform the requesting entity why the provisioning request was denied, and to prompt the requesting entity to submit a new provisioning request complying with the size limit.

Optionally, CMU 303 may determine whether the requesting entity is authorized to provision a database for the duration of time specified in the provisioning request. For example, if User 2 requests provisioning of a database for a two week lease term, and CMU 303 determines User 2 only possesses authorization to provision databases for a maximum of one week, CMU 303 may deny the provisioning request and/or may prompt User 2 to reduce the length of the requested lease term to one week or less.

In another example, when processing the provisioning request, CMU 303 may determine at least one of whether the requesting entity has exceeded their total allotted number of databases that can be created and whether the requesting entity has exceeded their total allocated amount of capacity. For instance, CMU 303 may limit the number of databases, or total amount of storage capacity, that may be created by a particular requesting entity. In an example, CMU 303 may limit a particular requesting entity to creating of no more than twenty databases. If the requesting entity includes members of a Design Group, for example, when any member attempts to create a twenty-first database, CMU 303 may deny the provisioning request.

If the database being provisioned is an existing database, CMU 303 may also verify whether the requesting entity has rights to at least one of access, modify, and deactivate the existing database. In some instances, a database may contain confidential information. CMU 303 may provide database security by, for example, use of authorized user lists, encryption, passwords, and the like. An authorized user list may be generated from a variety of sources including, for example, by user input (e.g., via workstation 201), by software, or predetermined based on other parameters of a database. In an embodiment, CMU 303 may monitor users who have accessed the database, including, for example, the time access began, time access ended, length of time access lasted, date access was granted, network address (e.g., Internet Protocol address) used to access the database, user name used to access the database, among other information. Alternatively or additionally, CMU 303 may maintain a list of unauthorized users who attempted to access the database. CMU 303 may transmit an alert following one or more database access attempts by an unauthorized user. Following a predetermined number of access attempts by an unauthorized user, CMU 303 may block additional access attempts by the unauthorized user, for example, by blocking access to the database by the network address utilized by the unauthorized user.

In addition to verifying rights of the requesting entity, CMU 303 may confirm that the database server 304 has sufficient capacity to provision the requested database, as described in further detail below. Capacity may include one or more of processing capacity, memory capacity, storage capacity, as well as other types of capacities. In an example, CMU 303 may compare the requested database storage capacity to available storage capacity of database server 304. For instance, if a 5 GB database is requested, but database server 304 only has 4 GB of storage capacity available, CMU 303 may deny the provisioning request. CMU 303 may also query other database servers to determine whether any has sufficient storage capacity before denying the request. Alternatively or additionally, if a provisioning request is denied on the basis of insufficient storage capacity, CMU 303 may inform workstation 201 of the available storage capacity and inquire as to whether a smaller database is acceptable. For example, if a provisioning request for a 10 GB database is made, but database server 304 only has 7 GB of available storage capacity, CMU 303 may prompt requesting entity (e.g., via workstation 201) as to whether a database only having a capacity of 7 GB would be acceptable. The provisioning request may similarly request one or more of a predetermined amount of processing capacity and a predetermined amount of memory capacity. CMU 303 may determine whether sufficient storage, processing, and memory capacity are available at one or more database servers 304 to satisfy the provisioning request.

As part of determining whether database server 304 has sufficient capacity, CMU 303 may determine available capacity over the duration of the requested lease term. In an example, CMU 303 may determine a peak storage capacity for database server 304 over the lease term, may aggregate the requested storage capacity with the peak storage capacity to determine an aggregate storage capacity, and compare the aggregate storage capacity to a maximum storage capacity. In an example, the maximum storage capacity may be less than a total amount of storage capacity for database server 304 (e.g., 95% of total storage capacity). If the aggregate storage capacity is less than the maximum storage capacity, CMU 303 may authorize provisioning of the database. Otherwise, CMU 303 may deny the request or prompt the requesting entity to modify their request. In an example, the provisioning request may be a request to create a new 100 gigabyte database. CMU 303 may determine how much storage capacity has been requested over the time period specified in lease term (e.g., over next 60 days) and may identify a peak storage capacity of the lease term (e.g., 500 gigabytes on day 31). In this example, database server 304 may have a total storage capacity of 750 gigabytes. CMU 303 may determine that the aggregate storage capacity of 600 gigabytes is less than the total storage capacity, and may authorize creation of the new database. CMU 303 may make similar determinations for available processing capacity and memory capacity, as well as other types of capacity, over the duration of the requested lease term.

CMU 303 may also recommend a modified lease term if sufficient capacity is only available for a portion of the requested lease term. For example, the provisioning request may request a lease term of 6 months and a database having a storage capacity of 200 gigabytes. Upon receiving of the provisioning request, CMU 303 may determine a peak storage capacity for the next six months. In this example, CMU 303 may determine that a database of the requested size may only be provisioned for the first three months, and that database server 304 lacks sufficient storage capacity for the last three months. CMU 303 may inform the workstation 201 that a database of the requested size can only be provisioned for three months and prompt the requesting entity as to whether the reduced lease term is acceptable. CMU 303 may either instruct database server 304 to create a database having the reduced lease term (e.g., 3 months) or deny the provisioning request. In the event a reduced lease term is assigned, CMU 303 may automatically extend the lease term to the requested lease term (e.g., full six months) if adequate storage capacity subsequently becomes available in the future. Alternatively or additionally, CMU 303 may also determine the largest capacity of database that may be provisioned for the next six months and inform the workstation 201 of the largest available capacity for the requested lease term. Workstation 201 may then prompt the requesting entity whether creating a database with the largest available capacity is acceptable.

Provided that the CMU 303 determines, in response to processing the provisioning request, that the requesting entity is authorized to provision a database, and the database server 304 has sufficient capacity to provision the requested database, CMU 303 may instruct the database server 304 to provision the requested database based on the requested or modified database parameters (e.g., reduced storage capacity, reduced lease term, reduced memory capacity, reduced processing capacity, and the like). If the database is a new database, database server 304 may create and store the database on, for example, local disk 305. CMU 303 may also generate an alert to the workstation 201 describing the details of the newly created database. Example details may include, for example, at least one of creation date, size of storage capacity, memory capacity, processing capacity, creator, database type, lease term length, and the like.

Subsequent to database creation, CMU 303 may monitor the lease term for each of the created databases and determine when a predetermined amount of time remains on any of the lease terms. When a predetermined amount of time or less remains on a particular lease term, CMU 303 may transmit an alert, for example, to workstation 201 regarding the upcoming expiration of the lease term. The alert may include, for example, an option to renew the database, the associated renewal cost, and the like. For example, CMU 303 may determine that a database has two weeks remaining on its lease term and may transmit an alert to workstation 201 about the upcoming expiration of the lease term. The alert may provide workstation 201 an option to renew the lease for a suggested time period (e.g., one additional month). CMU 303 may determine the suggested time based on, for example, available storage capacity of the database server 304, the size of the database, and how frequently the database was accessed. CMU 303 may also determine a cost for the renewal. The cost may be based on, for example, the size of the database, frequency of use of data from database, and the duration of the renewal time period. CMU 303 may similarly determine a cost when a database is initially created, and may prompt the requesting entity to agree to the cost prior to creation of the database.

Workstation 201 may reply by accepting the suggested time period or may specify another requested lease term. If renewed for the suggested time period, CMU 303 may update its records to include, for example, the renewed lease term expiration date. If the requesting entity requests a different time period, CMU 303 may verify the requested term is acceptable, as described in the foregoing (e.g., verifying that the requesting entity has sufficient rights, ensuring the requesting entity has authorization to request lease of requested length, verifying database server 304 and/or local disk 305 has sufficient capacity for requested lease term, and the like).

In other examples, at least one of CMU 303 and workstation 201 may automatically renew a lease term in the absence of prompting, and at any time prior to the expiration of the lease term. For example, CMU 303 may automatically renew a database in response to determining that the database has been accessed or modified at least a predetermined number of times within a predetermined amount of time. In an example, CMU 303 automatically renew a lease term for a database if the database has been accessed at least 50 times within the past two weeks. Alternatively or additionally, CMU 303 may limit a total number or duration of lease term renewals, or both.

Optionally, CMU 303 may identify infrequently used databases (e.g., less than a threshold number of uses within a given period) that are still within their lease term. For example, CMU 303 may rank all of the provisioned databases based on how frequently they are accessed. CMU 303 may determine that a database is infrequently used if it has been accessed less than a predetermined number of times (e.g., 50 times) within a time period (e.g., last two weeks). CMU 303 may prompt workstation 201 to terminate infrequently used databases prior to the end of their lease term. If no response is received, CMU 303 may automatically deactivate some or all of the infrequently used databases.

If the database lease term elapses without being renewed, CMU 303 may deactivate the database. Database deactivation may be accomplished in a variety of ways, including, for example, one or more of deactivating the list of authorized users for a database, transferring the data of the database to an alternate storage location (e.g., tape drive), and deleting the database from local disk 305, and the like. Alternatively or additionally, an expired database may remain in local disk 305 for a predetermined period of time following expiration to permit renewal of the lease term. Subsequent to deactivation, CMU 303 may alert workstation 201 about the deactivated database, which may include renewal information (e.g., information on how to renew, cost of renewal, suggestions on renewal period, and the like).

In further example aspects, CMU 303 may possess the ability to monitor databases and their usage. CMU 303 may maintain data on a total number of databases that have been provisioned, the requesting entities that have provisioned at least one database, and a ranking of the requesting entities based on the number of databases each have provisioned (e.g., user 1 has provisioned 30 databases, user 2 has provisioned 27 databases, and so forth). CMU 303 may also maintain information on peak storage capacity, storage utilization relative to size of requested database, how frequently each of the databases is used, peak memory utilization, peak processing utilization, and the like. For example, workstation 201 may request a list of databases and/or the corresponding frequency of usage.

In some examples, CMU 303 may provide a database provisioning platform based on capacity on demand. CMU 303 may include software logic and various trending data inputs to monitor capacity for satisfying user demand. CMU 303 may temporarily extend existing capacity (e.g., elasticity) as well as signaling the need to procure additional capacity. For example, CMU 303 may process information on database capacity utilization to determine that a group of database servers 304 associated with an organization are approaching a maximum capacity or exceed a predetermined utilization threshold (e.g., 95% of maximum capacity). CMU 303 may query other database servers in an attempt to reserve additional capacity (e.g., to temporarily extend existing capacity). CMU 303 may also inform appropriate personnel of an upcoming capacity shortage and request that additional hardware structure be procured prior to the capacity shortage.

Additionally, CMU 303 may offer a Database-as-a-Service (DaaS) platform, where the underlying setup and management of database infrastructure are abstracted from requesting entities. For instance, a requesting entity may simply select from a catalog of database choices, sizes, performance criteria, and optional services. CMU 303 may provision an appropriate database based on the selections and capacity statuses. An example service may be data mobility, where data may be copied to multiple locations, copied to different storage media, including network attached storage, loaded on multiple instances of database, preserved, and archived. CMU 303 may calculate a cost of usage based on any services provisioned. For example, CMU 303 may provide a ‘pay what you use’ product model. CMU 303 may determine a cost of usage based on lease term, database parameters, and any services provisioned.

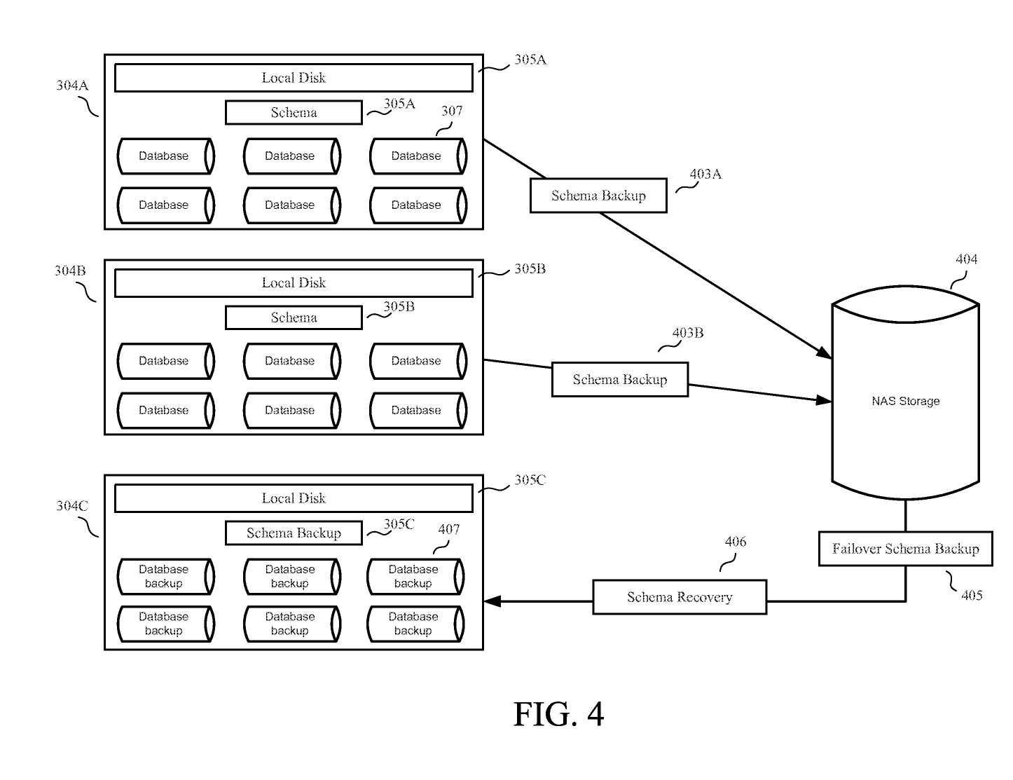

In some instances, one or more database servers 304 may periodically backup their stored databases and database schemas to an alternate location. FIG. 4 illustrates a system including multiple database servers in accordance with example embodiments of the disclosure. As seen in FIG. 4, the system may include database servers 304A-C communicatively coupled to network attached storage (NAS) 404. NAS 404 may include sub-types based on the following communication protocols such as, for example, network file system, common Internet file system, Internet small computer system interface, fibre channel, and the like. Database servers 304A-C and NAS 404 may communicate with one another, for example, via at least one of a wired network and a wireless network.

Each of the database servers 304A-C may include one or more local disks 305A-C that physically stores data for one or more databases 307 and data on one of more schema 305. In an example, database server 304C may be a failover database server that backs up one or both of database servers 304A-B. Each of the database servers 304A-B may periodically (e.g., daily) backup schema metadata by exporting a metadata on the one or more schema 306A-B. Schema and metadata backup may be performed to permit automated recovery of the database setup in the event of hardware failure. For example, server 304A may communicate a schema backup message 403A and server 304B may communicate a schema backup message 403B to NAS 404 for storage. In case of failure, schema data may be recovered from NAS 404 and forwarded to another database server 304 where capacity is available to restore a database using the schema data.

NAS 404 may also backup schema data in a failover database server 304C. In an example, NAS 404 may communicate a failover schema backup message 405 and a schema recovery message 406 to failover database server 304C. Failover database server 304C may store a schema backup 305C and one or more database backups 407 of one or more of databases 307.

As such, the example embodiments described herein may provide for requesting entities of an organization to share database server resources and control total cost of ownership of applications (TCOA) using centralized management of database provisioning.

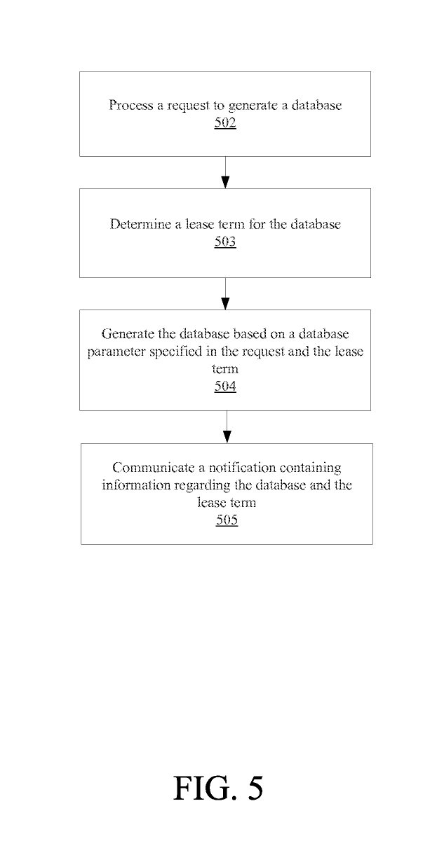

FIG. 5 illustrates an example flow diagram of a method, in accordance with example embodiments. The method may be performed by at least one apparatus such as, for example, a computer, server, or other computational device. For example, the method may be implemented by a single apparatus (e.g., computer) performing the functions of CMU 303. The method also may be implemented using two or more devices (e.g., two or more processors, systems, apparatuses, and the like). The order of the blocks shown in FIG. 5 is an example. The blocks may be arranged in other orders, each function described in each block may be performed one or more times, some blocks may be omitted, and/or additional blocks may be added. The method may begin at block 502.

In block 502, the method may include processing a request to generate a database. For example, user input is received via provisioning tool implemented by workstation 201, which communicates a provisioning request including at least one database parameter to CMU 303. Example parameters may include a requested lease term, size of the requested database, and the like.

In block 503, the method may include determining a lease term for the database. In an example, CMU 303 may determine a lease term for the database based on at least one of available capacity (e.g., processing capacity, storage capacity, memory capacity, and the like) of a database server 304 and a lease term requested by a requesting entity.

In block 504, the method may include generating a database based on a database parameter specified in the request and the lease term. In an example, CMU 303 may generate a database having capacity specified in the provisioning request for a period of time specified in the lease term.

In block 505, the method may include communicating a notification containing information regarding the database and the lease term. In an example, CMU 303 may generate and transmit a notification to at least the workstation 201 of the requesting entity. The notification may include information regarding the generated database, including, for example, the size of the database, the type of database, the storage location of the database, the requesting entity, the lease term, among other things. CMU 303 may monitor the lease term to determine when to prompt the requesting entity about whether to renew the lease term for a subsequent time period. If the lease term is not renewed, CMU 303 may deactivate the database. Deactivating the database may include, for example, restricting access to the database, deleting the database, moving the expired database to an alternative (e.g., back-up) location, and the like.

Aspects of the embodiments have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the embodiments.

1. An apparatus comprising:
at least one processor; and
at least one memory storing computer readable instructions that, when executed by the at least one processor, cause the apparatus at least to:
process a request to generate a database, wherein the request comprises a database parameter;
determine a lease term for the database;
generate the database based on the database parameter; and
communicate a notification containing information regarding the database and the lease term.

2. The apparatus of claim 1, wherein a duration of the lease term is an amount of time specified in a requested lease term included in the request.

3. The apparatus of claim 1, wherein a duration of the lease term is based on available capacity of a database server.

4. The apparatus of claim 1, wherein the computer executable instructions, when executed, cause the apparatus to:
determine an amount of time remaining on the lease term;
generate an alert, based on the amount of time remaining on the lease term; and
transmit the alert.

5. The apparatus of claim 1, wherein the computer readable instructions, when executed by the at least on processor, cause the apparatus to:
determine when the lease term expires; and
deactivate the database subsequent to expiration of the lease term.

6. The apparatus of claim 5, wherein the computer executable instructions, when executed, cause the apparatus to cause the database to be stored in an alternate storage location prior to deactivating the database.

7. The apparatus of claim 1, wherein the computer readable instructions, when executed by the at least on processor, cause the apparatus to:
process a second request to generate a second database, wherein the second request comprising a second database parameter;
modify the second database parameter; and
generate the second database based on the modified database parameter.

8. A computer-implemented method comprising:
processing a request to generate a database, wherein the request comprises a database parameter;
determining, by a processor, a lease term for the database;
generating the database based on the database parameter; and
communicating a notification containing information regarding the database and the lease term.

9. The method of claim 8, wherein a duration of the lease term is an amount of time specified in a requested lease term included in the request.

10. The method of claim 8, wherein a duration of the lease term is based on available capacity of a database server.

11. The method of claim 8, wherein the determining of the lease term is based on peak storage capacity of a database server.

12. The method of claim 8, further comprising:
determining an amount of time remaining on the lease term; and
generating an alert, based on the amount of time remaining on the lease term.

13. The method of claim 8, further comprising
determining when the lease term expires; and
deactivate the database subsequent to expiration of the lease term.

14. The method of claim 8, further comprising:
processing a second request to generate a second database, wherein the second request comprising a second database parameter;
modifying the second database parameter; and
generating the second database based on the modified database parameter.

15. A non-transitory computer readable medium storing computer readable instructions that, when executed, cause an apparatus at least to:
process a request to generate a database;
determine a lease term for the database; and
generate the database based on the request and the lease term.

16. The computer readable medium of claim 15, wherein a duration of the lease term is an amount of time specified in a requested lease term included in the request.

17. The computer readable medium of claim 15, wherein a duration of the lease term is based on available capacity of a database server.

18. The computer readable medium of claim 15, wherein the determining of the lease term is based on peak storage capacity of a database server.

19. The computer readable medium of claim 15, wherein the computer readable instructions, when executed, cause the apparatus to:
determine an amount of time remaining on the lease term; and
generate an alert, based on the amount of time remaining on the lease term.

20. The computer readable medium of claim 15, wherein the computer readable instructions, when executed, cause the apparatus to:
determine when the lease term expires; and
deactivate the database subsequent to expiration of the lease term.
